(19) United States
(12) Patent Application Publication
(10) Pub. No.: US 2015/0347402 A1
(43) Pub. Date: Dec. 3, 2015

(54) SYSTEM AND METHOD FOR ENABLING A CLIENT SYSTEM TO GENERATE FILE SYSTEM OPERATIONS ON A FILE SYSTEM DATA SET USING A VIRTUAL NAMESPACE

(71) Applicant: NetApp, Inc., Sunnyvale, CA (US)

(72) Inventor: James McKinion, Austin, TX (US)

(73) Assignee: NetApp, Inc., Sunnyvale, CA (US)

(21) Appl. No.: 14/290,854

(22) Filed: May 29, 2014

(51) Int. Cl. G06F 17/30

(52) U.S. Cl. CPC G06F 17/3007; G06F 17/30194

(57) ABSTRACT

A file system data set is scanned to (i) identify the file system objects of the file system data set, and (ii) obtain contextual data and metadata for file system objects of the file system data set. A virtual namespace for the file system data set is then constructed using the contextual data and the metadata. From a computer system, one or more atomic file system operations are issued to exercise the file system data set using the virtual namespace.

### TECHNICAL FIELD

Examples described herein relate to network-based file systems, and more specifically, to a system and method for enabling a client system to generate file system operations on a file system data set using a virtual namespace.

### BACKGROUND

Network-based file systems include distributed file systems which use network protocols to regulate access to data. Network File System (NFS) protocol is one example of a protocol for regulating access to data stored with a network-based file system. The specification for the NFS protocol has had numerous iterations, with recent versions NFS version 3 (1995) (See e.g., RFC 1813) and version 4 (2000) (See e.g., RFC 3010). In general terms, the NFS protocol allows a user on a client terminal to access files over a network in a manner similar to how local files are accessed. The NFS protocol uses the Open Network Computing Remote Procedure Call (ONC RPC) to implement various file access operations over a network.

Other examples of remote file access protocols for use with network-based file systems include the Server Message Block (SMB), Apple Filing Protocol (AFP), and NetWare Core Protocol (NCP). Generally, such protocols support synchronous message-based communications amongst programmatic components.

### BRIEF DESCRIPTION OF THE DRAWINGS

FIG. 1 illustrates an example client system that utilizes a virtual namespace to generate file system operations on a file system data set.

FIG. 2 illustrates an example method for enabling a client system to exercise a file system dataset.

FIG. 3 illustrates an example for scanning a file system dataset using a depth first prioritization to determine information for building a virtual namespace that represents the file system dataset.

FIG. 4 illustrates an example method for identifying and accounting for hardlinks to inodes of the file system dataset when building a virtual namespace representation of the file system dataset.

FIG. 5 is a block diagram that illustrates a computer system upon which embodiments described herein may be implemented.

### DETAILED DESCRIPTION

Examples described herein provide for a client system that exercises a file system data set using a virtual namespace. According to one aspect, the file system data set is scanned to identify (i) the file system objects contained within the file system data set, and (ii) contextual data and metadata for each of the identified file system objects of the file system data set. A virtual namespace for the file system data set is constructed using the contextual data and the metadata. From a computer system, one or more file system operations are issued to exercise the file system data set using the virtual namespace.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component can exist in a hardware component independently of other modules/components or a module/component can be a shared element or process of other modules/components, programs or machines. A module or component may reside on one machine, such as on a client or on a server, or may alternatively be distributed among multiple machines, such as on multiple clients or server machines. Any system described may be implemented in whole or in part on a server, or as part of a network service. Alternatively, a system such as described herein may be implemented on a local computer or terminal, in whole or in part. In either case, implementation of a system may use memory, processors and network resources (including data ports and signal lines (optical, electrical etc.)), unless stated otherwise.

Furthermore, one or more embodiments described herein may be implemented through the use of instructions that are executable by one or more processors. These instructions may be carried on a non-transitory computer-readable medium. Machines shown in figures below provide examples of processing resources and non-transitory computer-readable mediums on which instructions for implementing one or more embodiments can be executed and/or carried. For example, a machine shown for one or more embodiments includes processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and tablets) and magnetic memory. Computers, terminals, and network-enabled devices (e.g. portable devices such as cell phones) are all examples of machines and devices that use processors, memory, and instructions stored on computer-readable mediums.

System Overview

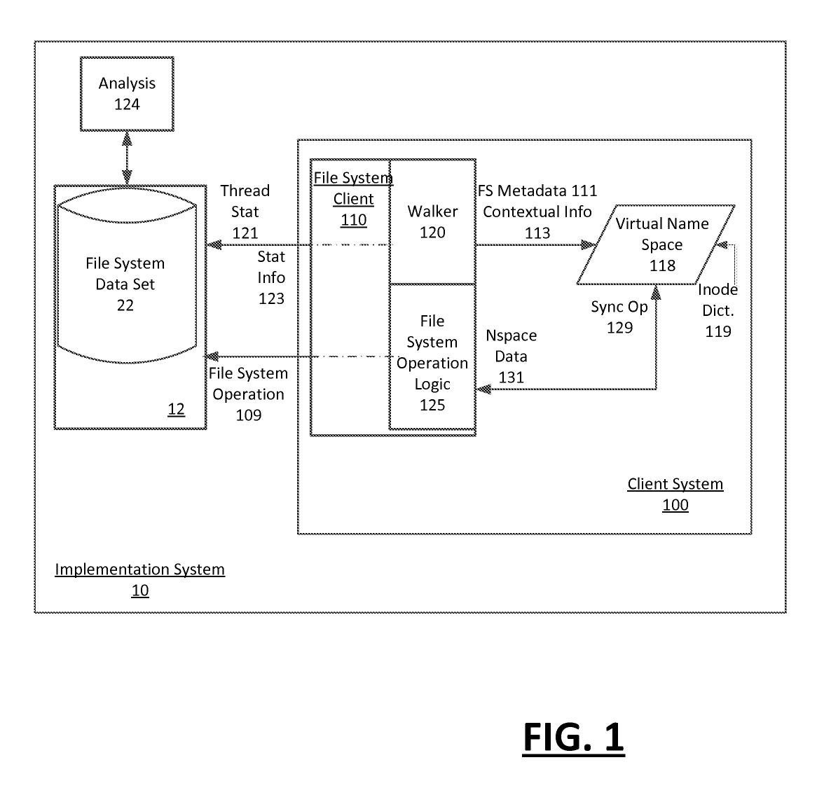

FIG. 1 illustrates an example client system that utilizes a virtual namespace to generate file system operations on a file system data set. In an example of FIG. 1, the client system 100 operates as part of an implementation system 10 which includes a filer 12 having a file system data set 22. The implementation system 10 can, for example, be provided as part of a test environment in which the client system 100 generates file system operations for the purpose of testing and evaluation. By way of example, the client system 100 can generate a load test on the filer 12. Examples recognize that in such computing environments, the client system 100 requires advance knowledge regarding the structure of the file system data set that is to be tested in order to operate efficiently. For example, in load testing environments, conventional approaches typically use a pre-defined file system data set, for which the structure of the file system data set is already known or that can be easily derived, in order to enable a client system to generate file system operations that are designed to load test a filer. However, under the conventional approaches, the file system data set is not selected or derived for the particular situation (e.g., customer needing to test a file system), but rather the file system data set is generic or non-specific to the particular file system that is of interest.

Accordingly, examples recognize, a need to enable the use of file system data sets which are selected or specific to a particular file system of interest, and not known in advance of their use within, for example, a test environment. For example, customers who wish to have a filer or aspect of their file system tested can generate file system data sets for testing using their existing and active file system data.

With reference to FIG. 1, client system 100 includes a file system client 110 and a virtual namespace 118. The file system client 110 can also include walker 120 and file system operation logic 125. The file system client 110 can interface with the filer 12 and the source file system data set 22 using, for example, an NFS interface. The walker 120 operates to scan the file system data set 22 of the filer 12 in order to discover information for constructing the virtual namespace 118. The client system 100 also includes a file system client 110 that issues file system operations 109 for the filer 12 using information derived from the virtual namespace 118. The file system client 110 includes file system operation logic 125, which accesses and maintains the virtual namespace 118 in conjunction with operations issued from the file system client 110.

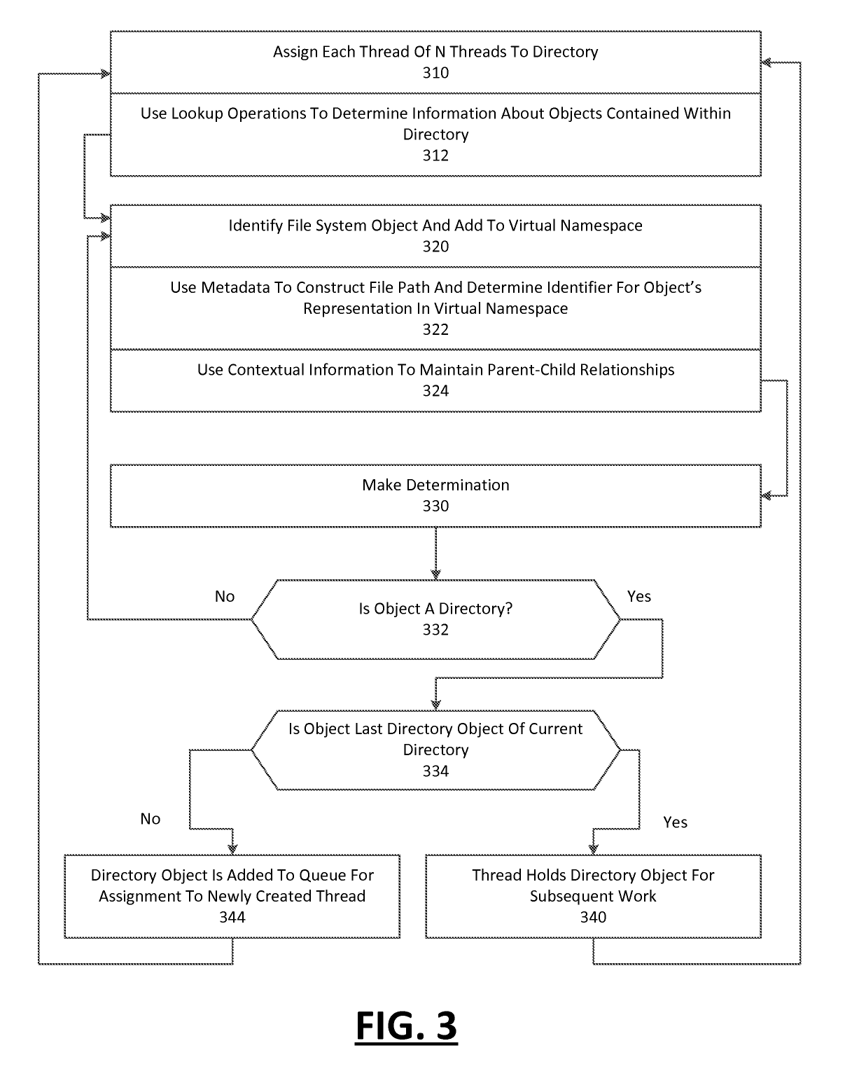

In more detail, the walker 120 issues multiple stat or lookup operations 121 that collectively scan the contents of the file system data set 22. According to an aspect, the walker 120 employs threads to execute the lookup operations 121. In one implementation, the lookup operations 121 collectively scan a hierarchy of the file system data 108 in accordance with a depth-first, recursive process. An example of a depth first, recursive process is illustrated with FIG. 3.

In executing the lookup operations 121, the walker receives lookup information 123. The walker uses the lookup information 123 to construct the virtual namespace 118. The lookup information 123 includes file system metadata 111 and contextual information 113. The file system metadata 111 can include metadata for individual file system objects of the file system data set 22. In one implementation, the metadata determined from the file system data set 22 can include, for example, the filename, inode, object type and hardlinks associated with individual file system objects. The contextual information 113 includes the parent-child hierarchical information about individual file system objects of the file system data set 22.

The virtual namespace 118 uses the metadata 111 and contextual information 113 to form a representation of the file system data set 22. In one implementation, the virtual namespace 118 is stored in the memory of the client system 100. In a variation, the virtual namespace 118 is stored externally to the client system 100. In one implementation, the virtual namespace is formatted in the hierarchical Extensible Markup Language (XML). In some implementations, the virtual namespace 118 contains object pathnames stored in the Unicode format, meaning on of the formats that comply with the Unicode standard. The use of such Unicode formats enables the virtual namespace 118 to represent non-trivial data sets, and further data sets that include foreign characters. The use of the virtual namespace 118 also accommodates data sets with file names that extend up to the maximum path length.

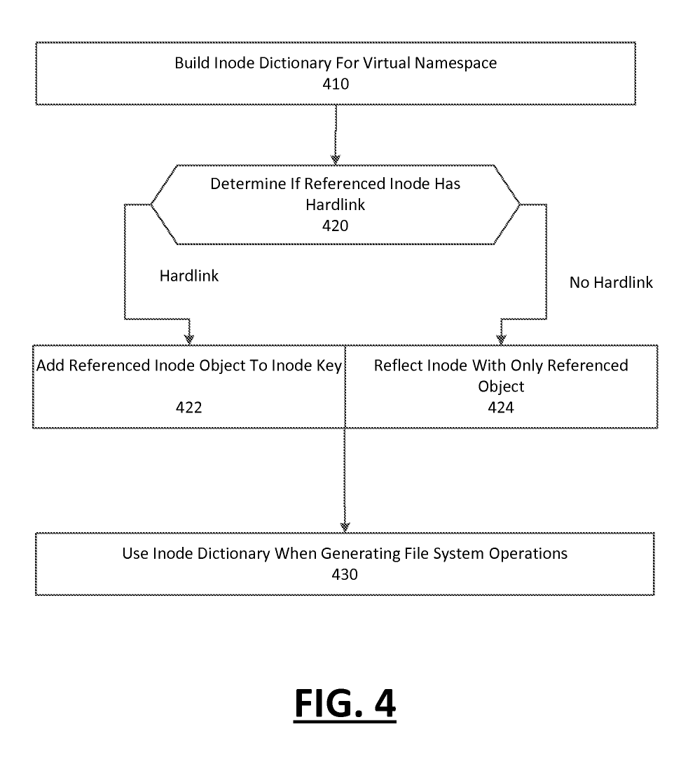

In one implementation, the virtual namespace 118 is paired with an inode dictionary 119 to track and account for the existence of hardlinks. The inode dictionary 119 can correspond to an associative array, map or symbol table. The walker 120 can identify file system objects and the corresponding inodes for each file system object. When hardlinks exist, multiple file system objects can be associated to the same inode. The inode dictionary references an inode key for each inode of the file system data set 22, and further a value that indicates a referenced file system object from the virtual namespace for the inode. When hardlinks exist, the inode key for an inode references multiple values to identify the file system objects that are referenced by the hardlinks. FIG. 4 illustrates an example for implementing an inode dictionary in connection with a virtual namespace.

The file system client 110 receives namespace data 131 from the virtual namespace 118, and uses the namespace data 131 to generate the file system operations 109. The namespace data 131 can reflect identifiers and the file paths of individual objects of the file system data set 22. Examples recognize that absent some a priori information about the file system data set 22, the file system client 110 would not be able to generate file system operations without first performing operations to discover the structure of the file system data set 22. In contrast, an example of FIG. 1 enables the file system client 110 to issue file system operations 109 based on virtual namespace 118 that is built from the file system data set 22, and the virtual namespace 118 provides a representation of the file system data set 22. Accordingly, the use of the virtual namespace 118 enables the file system client 110 to issue file system operations 109 that are tailored for the structure and hierarchy of the file system data set 22, without the need for the file system client 110 to perform additional operations to discover the structure of the file system data set 22.

According to one aspect, the file system client 110 can utilize the virtual namespace 118 to ensure that the generated file system operations are atomic. In one implementation, the representation of a file system object with the virtual namespace 118 can be provided a flag or semaphore which includes a value that indicates whether a file system operation is in progress. When the file system client 110 completes the file system operation, the flag or semaphore can be reset to reflect the prior operation is complete, and the file system object is once again available. As atomic operations, each file system object referenced by the virtual namespace 118 can only be referenced by one file system operation 109. By ensuring the file system operations 109 are atomic, two or more operations do not concurrently access a given file system object to cause inconsistency as to the state of the file system object for one or more multiple operations.

The file system client 110 can generate the file system operations 109 using different logical schemes. In one implementation, the file system client 110 uses the virtual namespace 118 to randomly identify file system objects that are specified by the operations 109. In a variation, the file system objects that are referenced by the virtual namespace 118 can be iterated in order to generate the file system operations 109.

The file system operation logic 125 of the file system client 110 can receive the virtual namespace data 131 in order to select or otherwise determine the type and construction of the file system operations 109. In one implementation, for example, the file system operation logic 125 implements random selection in determining the type of file system operations that are to be performed on the file system data set 22. In a variation, the file system operation logic 125 can use a priority scheme to select file system operations based on, for example, a sampling of file system operations performed on a corresponding active file system data set. Among other information, the namespace data 131 also identifies the inodes and the objects of the file system data set 22, along with the file paths of the various identified objects.

In addition to reading information from the virtual namespace 118, the file system client 110 can also issue commands to the virtual namespace 118 for purpose of maintaining coherency between the virtual namespace 118 and the file system client 110. In particular, the file system client 110 can detect when the issued file system operation 109 is of a type that could cause potential incoherency, and then issue commands or updates 129 to the virtual namespace 118 to account for the particular operation performed on the file system data set 22 on a corresponding object of the virtual namespace 118.

By way of the example, the particular types of operations that can cause incoherency in the virtual namespace 118 can include operations that are of a type of create, remove, move or rename. Accordingly, in one implementation, when such operations are detected as being initiated or performed on the file system data set 22, a corresponding command is issued to reflect the outcome of the file system operation on the corresponding objects of the virtual namespace 118.

The implementation system 10 such as shown by an example of FIG. 1 can be provided with one or more programmatic monitors or analysis components for a variety of purposes. In one implementation, for example, implementation system 10 is provided with components or modules for performing load analysis on, for example, the file system 12. An analysis module 124 can be equipped with logic to perform a variety of tasks related to load analysis. In one implementation, the analysis module 124 can operate as a separate module. In a variation, the load analysis module 124 can be provided with the file system 12, client system 100 or distributed therebetween.

Methodology

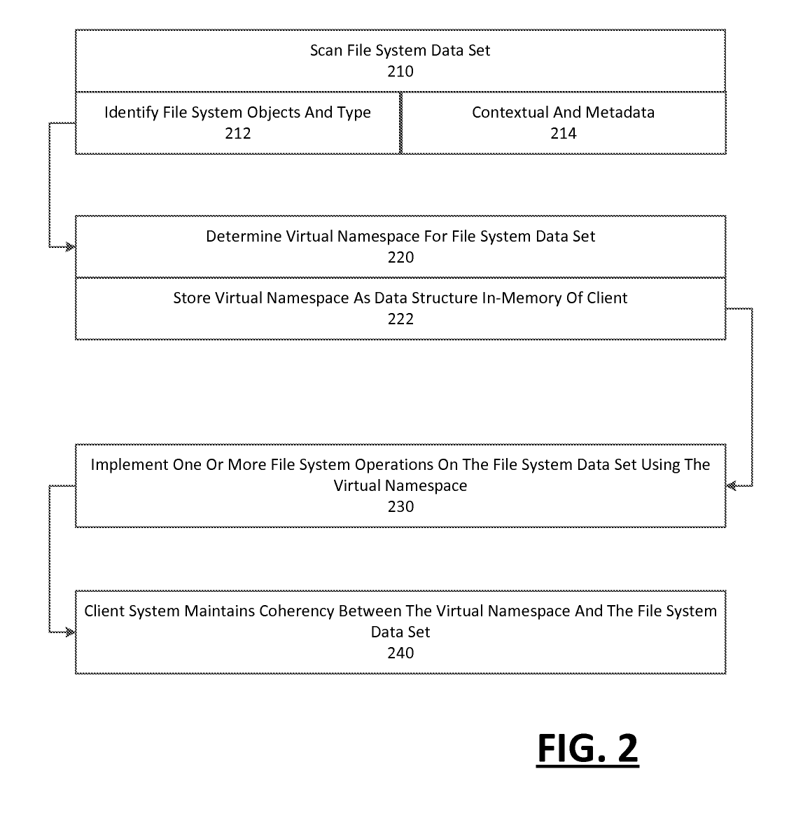

FIG. 2 illustrates an example method for enabling a client system to exercise a file system dataset. FIG. 3 illustrates an example for scanning a file system dataset using a depth first prioritization to determine information for building a virtual namespace that represents the file system dataset. FIG. 4 illustrates an example method for identifying and accounting for hardlinks to the inodes of the file system dataset when constructing a virtual namespace representation of the file system dataset. In describing examples of FIG. 2, FIG. 3 and FIG. 4, reference may be made to elements of FIG. 1 for purpose of illustrating a suitable component or element for performing a step or sub-step being described.

With further reference to FIG. 2, a file system dataset is scanned by client system 100 (210). The file system dataset can be maintained by filer 12, which includes logic for receiving and responding to file system operations specified from the client system 100. In examples provided, the file system dataset can be selected, configured or otherwise designated for use for the client system when no a priori information exists about the structure and/or hierarchy of the file system data set. Absent such information, conventional approaches require the client system 100 to issue individual discovery operations to locate the contents of the file system data set before issuing a file system operation. Further, other conventional approaches utilize predetermined file system data sets having established structure and hierarchy, but have little relevance to the file system that is to be tested or evaluated.

In one example, a test environment can be created in which the client system 100 operates to generate a load on a sample file system dataset. In such a test environment, the file system dataset can be selected from an active file system that is of interest. In contrast, conventional approaches typically use a test file system that is substantially the same in any testing environment, rather than being configured or selected for the particular test environment.

In scanning the file system dataset, individual file system objects are identified, and the type of each identified object is recorded (212). In one implementation, the walker 120 corresponds to a logical component provided on the client system 100. The walker 120 performs a series of lookup or stat operations to identify information about the file system dataset, including metadata and contextual information for individual objects that reside in the file system dataset (214). The metadata that is determined from scanning the file system dataset enables the construction of a file path for that object. The contextual information reflects relationships among individual file system objects, specifically in the context of parent-child. In addition, the type of each object in the file system dataset can be counted and tracked separately.

The virtual namespace 118 can be constructed for the file system dataset based on information obtained from scanning the file system dataset (220). In this way, the virtual namespace 118 is built to provide a representation of the file system dataset, and provides information for the client system 100 regarding the structure and hierarchy of the file system dataset. According to one aspect, the virtual namespace 118 can be stored in memory with the client system 100 (222), to enable rapid access to data needed for issuing file system operations to the file system 12.

The client system 100 can utilize the virtual namespace 118 in order to construct file system operations according to predetermined logic that is specific to the particular implementation system 10 (e.g., test environment) or file system dataset 22 (230). In this way, the virtual namespace 118 enables the client system 100 to construct file system operations in a manner that is autonomous or substantially autonomous, and further tailored for the implementation system 10 and file system dataset 22. Furthermore, the virtual namespace 118 can ensure that file system operations which issue from the file system client 110 are atomic, so that any given file system object is only referenced by one file system operation at a time.

According to one aspect, the client system 100 maintains coherency between the file system dataset 22 and the virtual namespace 118 (240). The client system 100 is aware of those file system operations that generate incoherency between the file system data set 22 and the virtual namespace 118. Information reflecting the creation, removal, renaming or moving of individual file system objects which causes incoherency are then used to update the virtual namespace 118. By way of example, client system 100 can issue commands to logic maintaining the virtual namespace 118 to reflect file system objects that are created, removed, or renamed on the file system dataset 22. In this way, the client system 100 can maintain coherency of the virtual namespace 118 in real-time, while issuing file system operations 109 on the file system dataset 22.

With reference to FIG. 3, walker 120 can implement a depth first priority scheme in order to discover information about the contents the file system dataset. The performance of walker 120 can be independent and in advance of file system client 110 issuing file system operations for the file system dataset 22. According to one aspect, the walker 120 can generate multiple (N) threads, each of which perform lookup or stat operations in accordance with a sequence that is based on the determined structure of the file system dataset 22. In one implementation, the walker 120 can assign individual threads to a directory of the file system dataset 22 (310). The file system dataset 22 can be nontrivial, with the number of file system objects present exceeding the order of 10EXP6. In one implementation, walker 120 generates and assigns individual threads to unique directories, starting with the root level of the file system dataset 22. Accordingly, the walker 120 collectively employs multiple threads recursively and in accordance with depth-first prioritization. A thread is assigned to a directory object, beginning with the root node, and subject objects encountered in that directory are noted as the children of that object.

The walker 120 executes each thread to generate lookup operations 121 for a directory assigned to that thread, and each lookup operation 121 queries the filer 12 to return information about corresponding objects of that directory (312). The information that is returned for the individual objects includes metadata that identifies the object and further enables the construction of a file path in the virtual namespace 118. Furthermore, the information that is returned can also identify a type of object that is identified from a particular directory. By way of example, the file system objects can correspond to directories, files, hardlinks, symbolic links, sockets, FIFO devices, block devices or char devices. Furthermore, the information that is returned by execution of the lookup operations can include contextual information.

As each object within a given unique directory is identified, the object is then added to the virtual namespace (320). The metadata is used in part to construct the file path and identifier for the object's representation in the virtual namespace 118 (322). Furthermore, the contextual information is used to add the object to the virtual namespace 118 in accordance with a hierarchy that reflects the relationship of that object with a parent object in the file system dataset 22 (324). Each object that is discovered from the file system data set 22 is associated with that object's parent, and the discovered file system object is added to the virtual namespace 118 with the association to the object parent maintained. For example, in one implementation, the file system object is added underneath the current parent object to maintain the parent child relationship structure.

In some variations, an exclusion list is maintained which identifies objects of the file system data which are not to be represented in the virtual namespace 118. In such implementations, each thread can compare a newly discovered object against objects contained in the exclusion list, and then add that object to the virtual namespace 118 only if the object is not on the exclusion list.

With each file system object of the filer 12 that is identified by one of the multiple threads that are in progress (330), a determination is made as to whether the object is a directory object (332). If the object is not a directory object, (330) is repeated to identify the next object of the directory. If the thread (as implemented by the walker 120) determines that the object is a directory object, then a determination is made as to whether the directory object is the last directory object of the particular directory (334). If the thread determines that a discovered directory object is the last one of the directory, then the thread holds the directory object until the scan of the current directory is complete, then initiates a new scan on the last directory object, with the last directory object becoming the parent object of children that are then sorted by the particular thread (340). This allows for the new directory to be scanned without the need for the walker 120 to create a new thread. The process for the last directory is repeated at (310).

If the determination is that the discovered directory object is not the last directory object of the directory being scanned, then the newly discovered directory object is added to a thread work queue (344). The walker 120 then generates a new thread for the newly added directory from the thread work queue, and the process repeats at (310).

With reference to FIG. 4, some embodiments provide for instances in which the file system dataset includes hardlinks. Hardlinks are data items that reference file system objects to inodes, and the use of hardlinks permits multiple file system objects to reference the same inode. Examples described herein recognized that in creating a virtual namespace which represents the file system dataset, the existence of hardlinks in the file system dataset can, among other problems, lead to incoherency or other problems in the manner that the virtual namespace is maintained when file system operations are issued on the file system dataset using information provided from the virtual namespace.

In one implementation, an inode dictionary is built for the virtual namespace 118 (410). The inode dictionary can correspond to, for example, an associative array, map or symbol table. The inode dictionary can include an inode key, and one or more values which identify virtual namespace objects which reference that inode.

The virtual namespace objects which reference the inode are dependent on hardlinks that exist in the file system data set 22. Accordingly, when a file system object is to be added to the virtual namespace 118, a determination is made as to whether the inode for that file system object has a hardlink (420). If the hardlink exists, then the inode dictionary for the virtual namespace reflects the particular inode with an extra value that represents the file system object with the hardlink (422). Otherwise, the inode dictionary of the virtual namespace 118 reflects the inode with a single value that references the file system object (424). In this way, the inode dictionary for the virtual namespace 118 includes inodes that reference (i) a single virtual namespace object when the corresponding file system object has no hardlinks, and (ii) multiple virtual namespace objects when the corresponding file system object is for an inode that includes one or more hardlinks for multiple other file system objects.

The inode dictionary is then used by the client system 100 when generating the file system operations (430). In particular, once determined, the inode dictionary for the virtual namespace 118 ensures that file system operations 109 generated on the file system data set 22 affect the hardlinked objects of the virtual namespace 118. This ensures that the virtual namespace 118 does not lose coherency with the presence of hardlinks in the file system data set 22.

Computer System

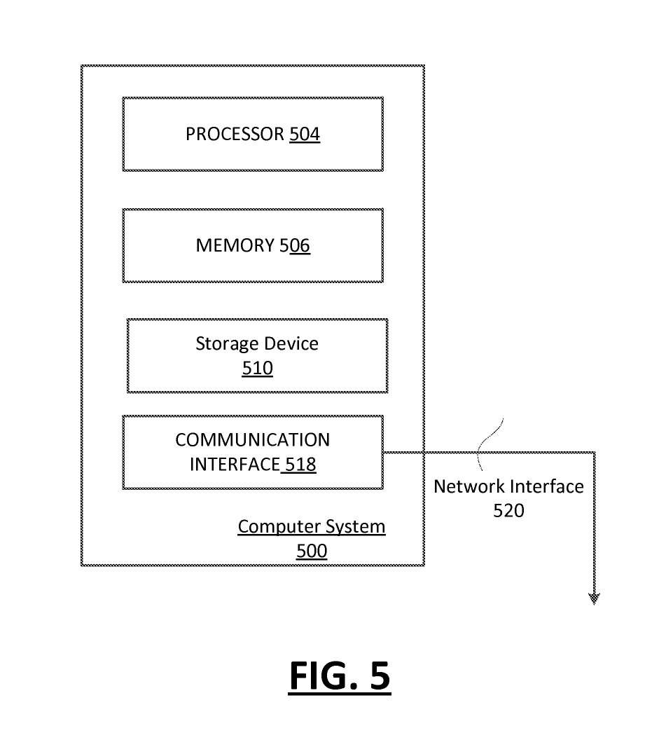

FIG. 5 is a block diagram that illustrates a computer system upon which embodiments described herein may be implemented. For example, in the context of FIG. 1, client system 100 may be implemented using one or more computer systems such as described by FIG. 5. Still further, methods such as described with FIG. 2, FIG. 3 and FIG. 4 can be implemented using a computer such as described with an example of FIG.

In an example, computer system 500 includes processor 504, memory 506 (including non-transitory memory), storage device 510, and communication interface 518. Computer system 500 includes at least one processor 504 for processing information. Computer system 500 also includes a memory 506, such as a random access memory (RAM) or other dynamic storage device, for storing information and instructions to be executed by processor 504. The memory 506 also may be used for storing temporary variables or other intermediate information during execution of instructions to be executed by processor 504. Computer system 500 may also include a read only memory (ROM) or other static storage device for storing static information and instructions for processor 504. A storage device 510, such as a magnetic disk or optical disk, is provided for storing information and instructions. The communication interface 518 may enable the computer system 500 to communicate with one or more networks through use of the network link 520 (wireless or wireline).

In one implementation, memory 506 may store instructions for implementing functionality such as described with an example of FIG. 1, or implemented through an example method such as described with FIG. 2, FIG. 3 or FIG. 4. Likewise, the processor 504 may execute the instructions in providing functionality as described with FIG. 1, or performing operations as described with an example method of FIG. 2, FIG. 3 and FIG. 4.

Embodiments described herein are related to the use of computer system 500 for implementing the techniques described herein. According to one aspect, those techniques are performed by computer system 500 in response to processor 504 executing one or more sequences of one or more instructions contained in the memory 506. Such instructions may be read into memory 506 from another machine-readable medium, such as storage device 510. Execution of the sequences of instructions contained in memory 506 causes processor 504 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an example, can be combined with other individually described features, or parts of other embodiments. Thus, absence of describing combinations should not preclude the inventor(s) from claiming rights to such combinations.

What is claimed is:

1. A method for operating a client system to exercise a file system data set, the method being implemented by one or more processors and comprising:
scanning the file system data set to (i) identify the file system objects of the file system data set, and (ii) each of contextual data and metadata for file system objects of the file system data set;
determining a virtual namespace for the file system data set using the contextual data and the metadata; and
implementing, from a client computer, one or more file system operations on the file system data set using the virtual namespace.

2. The method of claim 1, further comprising updating the virtual namespace based on the one or more file system operations so that the virtual namespace is coherent with the file system data set.

3. The method of claim 2, wherein updating the virtual namespace includes (i) detecting file system operations which create, remove, or rename a file system object of the file system dataset, and (ii) updating the virtual namespace to the created, removed, or renamed file system object.

4. The method of claim 1, wherein scanning the file system data set includes generating multiple threads that scan a hierarchy of the file system data set using a depth first priority.

5. The method of claim 1, wherein scanning the file system data set includes detecting multiple kinds of file system objects, and maintaining a count of each of the multiple kinds of objects that are detected in the file system data set.

6. The method of claim 1, further comprising maintaining the virtual namespace within a data structure stored in a memory resource of the client computer.

7. The method of claim 1, further comprising determining the one or more file system operations based on the virtual namespace, the one or more file system operations being selected to evaluate the file system data set.

8. The method of claim 1, wherein scanning the file system data set includes:
detecting file system objects of the file system data set which include hardlinks; and
associating corresponding objects of the virtual namespace with the detected hardlinks.

9. The method of claim 8, wherein scanning the file system data set includes maintaining an inode dictionary for the virtual namespace, including associating each inode that is referenced by file system objects of the file system data set with a set of values, the set of values for each inode indicating a number of hardlinks that are provided with that inode.

10. The method of claim 1, wherein the virtual namespace object paths are formatted in Unicode.

11. A non-transitory computer-readable medium that stores instructions, that when executed by one or more processors, cause the one or more processors to perform operations comprising:
scanning the file system data set to (i) identify the file system objects of the file system data set, and (ii) each of contextual data and metadata for file system objects of the file system data set;
determining a virtual namespace for the file system data set using the contextual data and the metadata; and
implementing, from a client computer, one or more file system operations on the file system data set using the virtual namespace.

12. The non-transitory computer-readable medium of claim 11, further comprising instructions, that when updated by one or more processors, cause the one or more processors to perform operations comprising:
updating the virtual namespace based on the one or more file system operations so that the virtual namepace is coherent with the file system data set.

13. The non-transitory computer-readable medium of claim 12, wherein updating the virtual namespace includes (i) detecting file system operations which create, remove, or rename a file system object of the file system dataset, and (ii) updating the virtual namespace to the created, removed, or renamed file system object.

14. The non-transitory computer-readable medium of claim 11, wherein scanning the file system data set includes generating multiple threads that scan a hierarchy of the file system data set using a depth first priority.

15. The non-transitory computer-readable medium of claim 11, wherein scanning the file system data set includes detecting multiple kinds of file system objects, and maintaining a count of each of the multiple kinds of objects that are detected in the file system data set.

16. The non-transitory computer-readable medium of claim 11, further comprising instructions that, when executed by the one or more processors, cause the one or more processors to perform operations comprising:
maintaining the virtual namespace within a data structure stored in a memory resource of the client computer.

17. The non-transitory computer-readable medium of claim 11, further comprising determining the one or more file system operations based on the virtual namespace, the one or more file system operations being selected to evaluate the file system data set.

18. The non-transitory computer-readable medium of claim 11, wherein scanning the file system data set includes:
detecting file system objects of the file system data set which include hardlinks; and
associating corresponding objects of the virtual namespace with the detected hardlinks.

19. The non-transitory computer-readable medium of claim 18, wherein scanning the file system data set includes maintaining an inode dictionary for the virtual namespace, including associating each inode that is referenced by file system objects of the file system data set with a set of values, the set of values for each inode indicating a number of hardlinks that are provided with that inode.

20. A client computer system comprising:
memory resources that store a set of instructions and a virtual namespace;
one or more processors that use the instructions to:
scan the file system data set to (i) identify the file system objects of the file system data set, and (ii) each of contextual data and metadata for file system objects of the file system data set;
determine the virtual namespace for the file system data set using the contextual data and the metadata; and
implementing one or more file system operations on the file system data set using the virtual namespace.
